(19) United States
(12) Patent Application Publication
(10) Pub. No.: US 2009/0059831 A1
(43) Pub. Date: Mar. 5, 2009

(54) METHOD OF COMMUNICATING A MULTI-USER PACKET TO A GROUP OF USERS

(76) Inventors: Gang Li, Bridgewater, NJ (US); Ming Lu, Hillsborough, NJ (US); Martin H. Meyers, Montclair, NJ (US)

Correspondence Address: CARLSON, GASKEY & OLDS, P.C./Alcatel-Lucent, 400 W MAPLE RD, SUITE 350, BIRMINGHAM, MI, 48009, US

(21) Appl. No.: 11/846,016

(22) Filed: Aug. 28, 2007

(51) Int. Cl. H04J 3/24

(52) U.S. Cl. 370/312

(57) ABSTRACT

A disclosed method of communicating includes using a group identifier within a multi-user packet (MUP) to indicate at least one packet within the MUP is intended for a plurality of members of a group corresponding to the group identifier. In a disclosed example, the group identifier comprises a group MAC identifier that is included in a header of the MUP. Mobile stations receiving the MUP process the MUP to determine whether any individual user identifier or any group MAC identifier within the MUP indicates that an associated packet is intended for that mobile station. If so, the mobile station proceeds to process the associated packet or packets from within the MUP.

### 1. FIELD OF THE INVENTION

This invention generally relates to communication. More particularly, this invention relates to wireless communication.

### 2. DESCRIPTION OF THE RELATED ART

Wireless communication systems are in widespread use. Many new techniques and new system designs have been introduced over the years. One such new system design includes the evolution-data optimized (EVDO) system, which is intended to provide higher data rates to a mobile station, for example.

There is a desire to enhance the capability of EVDO systems. One proposal has been to use a broadcast mode to support group voice over Internet Protocol (VoIP) or multi-media calls such as push-to-talk (PTT) calls. If a broadcast mode is used, however, it may not be efficient enough because it does not take into account radio frequency conditions of individual mobile stations. Additionally, broadcast modes have to include very conservative assumptions regarding mobile channel conditions. Mobile stations with good RF channel conditions are served with the same data rates as mobile stations having bad RF conditions. Accordingly, some of the mobile stations may receive a level of service that is less than what it is otherwise capable of receiving.

Another proposal for supporting such group calls is to use a unicast mode where each member of the group is served as an individual user. One feature introduced in EVDO systems that can be used in a unicast mode is the multi-user packet (MUP) for serving multiple individual mobile stations. A single MUP includes a plurality of individual traffic payload packets, each intended for an individual mobile station. Up to eight individual users may be served by a single MUP. A header associated with each individual packet includes a MAC user identifier that indicates for which user each packet is intended. A mobile station receiving a MUP monitors the MUP to determine when any of the MAC user identifiers in the MUP indicates that a packet is intended for that mobile station. If so, the mobile station proceeds to process the associated packet that was intended for it. Otherwise, a mobile station will discard a received MUP.

When the number of mobiles in a group is relatively small, the unicast mode can be useful. If the number of mobiles in the group within a sector exceeds a threshold, however, the unicast mode is not effective even when MUPs are utilized. There is a need for a technique to efficiently service group calls in an EVDO system.

### SUMMARY

An exemplary method of communicating includes using a group identifier within a multi-user packet (MUP) to indicate at least one packet within the MUP is intended for a plurality of members of a group corresponding to the group identifier.

In one example, the group identifier comprises a group MAC identifier that is processed at a MAC layer of a receiving mobile station.

The various features and advantages of this invention will become apparent to those skilled in the art from the following detailed description. The drawings that accompany the detailed description can be briefly described as follows.

### BRIEF DESCRIPTION OF THE DRAWINGS

FIG. 1 schematically illustrates selected portions of a wireless communication system that is useful with an embodiment of this invention.

FIG. 2 is a flowchart diagram summarizing one example process.

### DETAILED DESCRIPTION

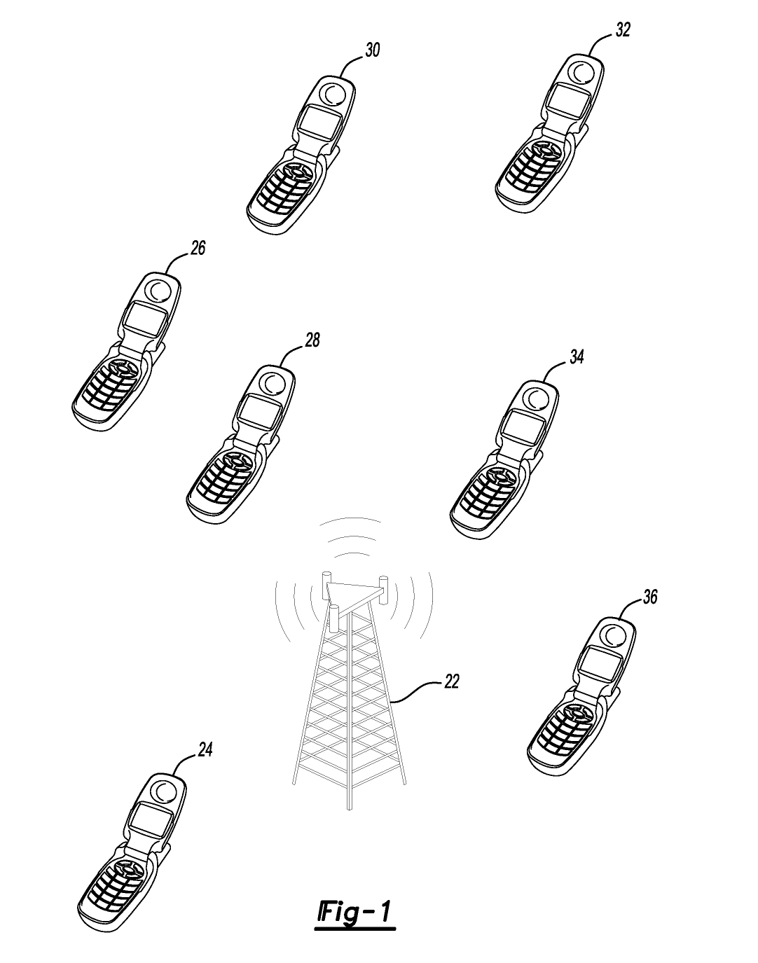

FIG. 1 schematically illustrates selected portions of a wireless communication system including a base station or access point 22. The base station 22 serves at least one sector within which a plurality of mobile stations may be conducting wireless communications at any given time. The illustrated example includes mobile stations 24-36 that are each involved in ongoing wireless communications within at least one sector served by the base station 22.

In one example, the base station 22 is part of a EVDO system that supports multi-user packet (MUP) transmissions. As known, MUPs include a plurality of traffic payload packets intended for a plurality of users that are grouped into the MUP and transmitted on a forward link during a single send of the MUP. The MUP includes user identifiers in a header portion of the MUP. The user identifiers indicate which mobile stations are the intended recipients of corresponding packets within the MUP.

The illustrated example includes the ability to send a packet within a MUP to a group of mobile stations using a single, group identifier within the MUP to indicate that at least one packet within the MUP is intended for members of that group. The group identifier facilitates communicating a packet to a plurality of users without having to use a corresponding plurality of user identifiers and a plurality of packets with the same traffic payload.

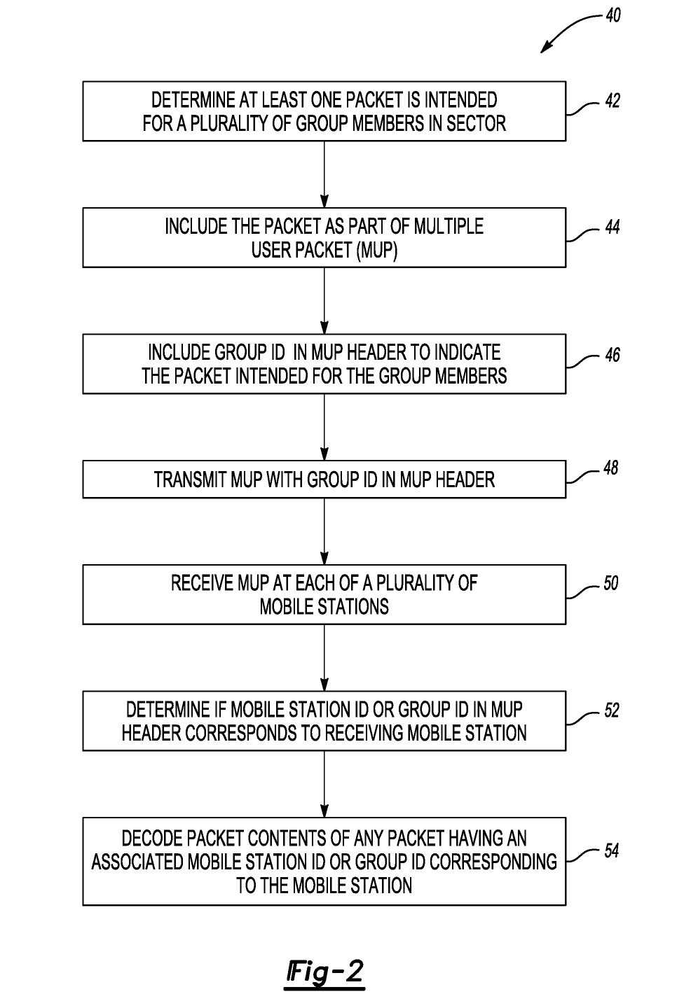

The flowchart diagram 40 of FIG. 2 summarizes one example approach. At 42, a determination is made that at least one packet is intended for a plurality of group members currently in a sector. That packet is included as part of a MUP at 44. Instead of using individual user identifiers for the members of the group and repeating the packet a corresponding number of times within the MUP, a single group identifier is associated with the packet and included in the MUP at 46. In one example, the group indicator comprises a MAC identifier that is embedded in each MAC packet header. For example, the MAC group identifier is included in the MAC index portion of the MAC packet header.

The group identifier (e.g., group MAC identifier) is assigned to any mobile station within a sector that is a member of a group known to an appropriate controller responsible for communications within that sector. For example, a plurality of mobile subscribers may be a member of a group subscribing to PTT call services. When there are multiple mobile stations within a single service group or call group located in the same sector, one packet (e.g., traffic payload) intended for members of that group can be carried in a MAC packet with the group MAC identifier in the associated header so that the MAC packet can be delivered as any other MAC packet within a MUP. The group MAC identifier allows for including the packet intended for the group of users in a manner consistent with including a packet intended for an individual user except that the group MAC identifier for that packet corresponds to a group of users instead of an individual user.

At 48, the MUP is transmitted with the group identifier in the MUP header. Of course, other packets within the MUP may be intended for individual users. Such packets will have an associated user identifier that indicates the individual user for which each packet is intended. Referring to FIG. 1, assume a MUP includes four traffic payload packets with one of them being intended for the mobile station 24, another being intended for the mobile station 30, a third being intended for the mobile station 36 and a fourth being intended for a group to which the users of the mobile stations 26, 28, 32 and 34 belong. This example MUP includes a user identifier associated with each packet. The first packet will include a user identifier that indicates the user of the individual mobile station 24, the second packet identifier will indicate the user of the mobile station 30, the third packet identifier will indicate the user of the mobile station 36. The packet identifier associated with the fourth packet is a group identifier indicating the group to which the users of the mobile stations 26, 28, 32 and 34 belong.

At 50 in FIG. 2, each mobile station receives the MUP. At 52, each mobile station processes the MUP header information to determine whether any packets within the header are intended for it. In this example, each mobile station determines whether an individual identifier assigned to it or a group identifier assigned to a group to which the user belongs is in the MUP header. If so, the mobile station proceeds to process and decode the packet contents of any packet having an associated individual user identifier or group identifier corresponding to that mobile station as shown at 54.

With the disclosed example, a single MAC packet in a MUP can be sent to multiple mobiles in the same call group. The current standard MUP structure allows for carrying payloads for up to eight users in a single MUP. By implementing the disclosed example embodiment of this invention, one of those users may comprise a group of users in place of an individual user by using a group identifier in place of an individual user identifier for a particular packet. This represents a significant potential increase in the throughput of such a system, or significantly reduce packet delay in such a system, because each MUP can now serve far more than eight individual users. For example, if there are ten members of a group within a sector, it is possible to serve all ten members of that group plus seven other users with seven other packets by sending a single MUP. Depending on the number of users within a particular group within a given sector, it is theoretically possible to service an unlimited number of users with a single MUP. Of course, utilizing multiple group IDs within a single MUP extends the benefit of the disclosed example even further.

One example includes notifying mobile stations of any group identifier assigned to them. In one example, group MAC identifier assignments are transmitted to mobile stations using layer 3 signaling messages. For example, a traffic channel assignment message containing the group MAC identifier assignment may be used to notify a mobile station of its group identifier. One example includes extending the traffic channel assignment message to contain group MAC identifier assignment information and making similar extensions in some mobile station parameter records. With the disclosed example, the required changes to existing systems and mobile stations is relatively limited and confined within MAC layer processing when the group identifier is a group MAC identifier. Other than some extension of call processing signaling, no hardware or ASIC changes are required in a mobile station, a base station or access node, for example.

One feature of the disclosed example is that the group identifier can be implemented as a group MAC identifier that fits within the established MAC index resources defined in the current standard. Implementing a group identifier in this manner does not require any changes to the lower layers of the standard and allows for flexibility in assigning a particular MAC index to an individual user MAC identifier or a group MAC identifier, depending on the needs at a particular time. The necessary extension of call processing signaling messages can be addressed by a service option definition or an addendum to a standard, for example.

Another feature of the disclosed example is that the simplified functions of a group MAC identifier allows for using MAC indexes that are not allowed to be used for individual user MAC identifiers. For example, the MAC indexes 66-70 are used in preambles to indicate a MUP and, therefore, these MAC indexes are not assigned to any individual mobiles as their individual user MAC identifier. These indexes can be used as a group identifier because they are not used for individual user identifiers. Additionally, the MAC indexes 2-3 and 71 are typically used in a preamble to indicate a control channel. These indexes are not used for individual identifiers and, therefore, could be used as a group MAC identifier. Additional indexes that qualify as potential group MAC identifiers include 0, 1, 64 and 65. Just by using these example MAC indexes to serve as group MAC identifiers within a particular sector allows for serving up to seven different groups without requiring any new MAC index values to be introduced.

Additionally, it is possible to assign one group MAC identifier to more than one group of users. In one example, a single group MAC identifier supports a plurality of call groups. Each call group has its own, unique encryption key. When a packet is received including the group MAC identifier in the header, the security layer at each mobile station will attempt to decode the packet contents. Any packets that cannot be decoded because they do not include the encryption key assigned to a particular group will be discarded by a mobile station that has a matching group MAC identifier but is not a member of the group to which the packet was intended to be sent.

While a MAC identifier is used as an example group identifier, it is also possible to use a mask-based method or a pointer-based method to establish a group identifier that facilitates sending a packet to a group of users consistent with the operation described above.

One feature of the disclosed example is that it allows for facilitating communications on behalf of a larger number of users including users within a group without requiring a broadcast mode. In addition to avoiding the disadvantages of a broadcast mode described above, there is no neighboring cell interference management issues that would otherwise be introduced by a broadcast mode. Further, there is no need to incorporate additional broadcast network components, which would introduce additional costs. Instead, the disclosed examples present an economically efficient way of serving groups of users and an increased number of total users that maximizes savings in forward link slots.

The preceding description is exemplary rather than limiting in nature. Variations and modifications to the disclosed examples may become apparent to those skilled in the art that do not necessarily depart from the essence of this invention. The scope of legal protection given to this invention can only be determined by studying the following claims.

We claim:

1. A method of communicating, comprising:
using a group identifier within a multi-user packet (MUP) to indicate that at least one packet within the MUP is intended for a plurality of members of a group corresponding to the group identifier.

2. The method of claim 1, wherein the group identifier comprises a group MAC identifier.

3. The method of claim 2, comprising
including the group MAC identifier in a header of the MUP; and
transmitting the MUP with the MAC identifier in the header.

4. The method of claim 3, comprising
including the group MAC identifier in a header associated with the at least one traffic payload packet intended for the plurality of members of the group.

5. The method of claim 3, comprising
including at least one other MAC identifier in the header of the MUP, the at least one other MAC identifier indicating that at least one other packet within the MUP is intended for a single mobile subscriber that is not part of the group corresponding to the group identifier.

6. The method of claim 3, comprising
determining that the at least one packet is intended for a plurality of members of a group currently within a single sector as a prerequisite to using the group MAC identifier.

7. The method of claim 2, comprising
receiving the MUP at a mobile station; and
determining whether the group MAC identifier indicates that the at least one packet is intended for a user of the mobile station.

8. The method of claim 7, comprising
determining a content of the at least one packet if the group MAC identifier indicates that the at least one packet is intended for the user of the mobile station.

9. The method of claim 8, comprising
determining whether the group MAC identifier indicates that the at least one packet is intended for the user at a MAC layer of the mobile station; and
determining the content of the at least one packet at a security layer of the mobile station if the group MAC identifier indicates that the at least one packet is intended for the user of the mobile station.

10. The method of claim 1, comprising
assigning the group identifier to the group; and
notifying mobile stations of users belonging to the group of the assigned group identifier.

11. The method of claim 10, comprising
including a notification of the assigned group identifier in a signaling message; and
sending the message to any mobile station within the group.

12. The method of claim 1, comprising
receiving an assignment of the group identifier;
receiving an assignment of an individual user identifier;
receiving at least one MUP;
determining whether the received MUP includes at least one of the assigned group identifier or the assigned individual user identifier; and
determining a content of any packet within the MUP associated with either the assigned group identifier or the assigned individual user identifier.

13. The method of claim 1, comprising
including a plurality of group identifiers in the MUP associated with a corresponding plurality of packets.

14. The method of claim 1, wherein the group identifier indicates more than one distinct group and the method comprises using a different encryption key for each distinct group to distinguish packets intended for the respective groups.
